(19) United States
(12) Patent Application Publication
(10) Pub. No.: US 2008/0027738 A1
(43) Pub. Date: Jan. 31, 2008

(54) INCREASING BUSINESS VALUE THROUGH INCREASED USAGE AND ADOPTION

(75) Inventors: Ingo R. Friedrichowitz, Kirkland, WA (US); Kimberly A. Smith, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: MICROSOFT CORPORATION, Redmond, WA (US)

(21) Appl. No.: 11/461,354

(22) Filed: Jul. 31, 2006

(51) Int. Cl. G06Q 10/00; G06Q 30/00

(52) U.S. Cl. 705/1

(57) ABSTRACT

In accordance with one aspect of the present invention, a method for increasing customer business value through increased usage and adoption of information worker products is provided. The method includes envisioning a need of a customer, discovering a solution to address the need through the increased usage and adoption of an information worker product and realizing the solution with the customer. In addition, the method may also include tracking a business value change of the realized solution.

### BACKGROUND

While the majority of companies have made considerable investments and use of software products, such as Outlook®, Excel®, Word®, PowerPoint®, Lotus Notes®, CAD programs, Word Perfect®, Lotus 1-2-3®, and other productivity related software (generally referred to herein as “information worker products”) on a day to day basis, many lack understanding about how or why the latest versions of such information worker products, or the unused features (high-level features) of such products can add significantly more value to their business. For example, many companies typically do not upgrade to existing versions of information worker products and do not implement the usage of high-level functions/features of used versions of the products because they believe the current use is “good enough” and the upgrade, increased usage, and understanding of the products would be of little or no benefit to the company. As a result, companies are often uncertain whether they are receiving an adequate return on their investment in those products.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one aspect of the present invention, a method for increasing customer business value through increased usage and adoption of information worker products is provided. The method includes envisioning a need of a customer, discovering a solution to address the need through the increased usage and adoption of an information worker product and realizing the solution with the customer. In addition, the method may also include tracking a business value change of the realized solution.

In accordance with another aspect of the present invention, a computer-readable medium having computer executable components for envisioning a need of a customer that can be satisfied through increased usage and adoption of an information worker product is provided. The computer-readable medium includes an industry profile development component configured to obtain information about an industry in which the customer operates and to determine the customer's place within the industry. A pain point component is also provided which is configured to identify potential pain points of the customer that can be resolved or improved through increased adoption and usage of an information worker product. The computer-readable medium may also include a target audience determination component configured to identify a target audience within the customer's organization for which communication as to how to implement a particular solution should be accomplished. To assist in that communication, a business value briefing component is provided that is configured to generate business value briefing materials.

In accordance with another aspect of the present invention, a method for realizing a plan for improving business value of a customer through the increased usage and adoption of an information worker product is provided. The method includes refining a project plan for increasing usage and adoption of an information worker product and developing a project review schedule specifying times within a pilot program for reviewing and grading a progress of the project. The method may also include determining a baseline measurement of a customer pain point that is to be improved through the increased usage and adoption of the information worker product and implementing a pilot program to increase the usage and adoption of the information worker product. As the pilot program is performed, the method periodically reviews and measures a progress of the program.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a flow diagram illustrating the overall process for increasing business value through increased usage and adoption of an information worker product, in accordance with an embodiment of the present invention;

FIG. 2 is a block diagram of an envisioning subroutine, for envisioning the needs of a customer, in accordance with an embodiment of the present invention;

FIG. 3 is a block diagram of a discovery subroutine, for discovering a plan for increasing business value through increased usage and adoption of an information worker product, in accordance with an embodiment of the present invention;

FIG. 4 is a block diagram of a realization subroutine for realizing a discovered plan, in accordance with an embodiment of the present invention;

FIG. 5 is a graphical representation of an industry profile snapshot generated in accordance with an embodiment of the present invention;

FIG. 6 is a graphical representation of industry trends page that may be generated in accordance with an embodiment of the present invention;

FIG. 7 is a graphical representation of value creation levers, generated in accordance with an embodiment of the present invention;

FIG. 8 is a graphical representation of an exemplary list of hypothesized pain points of a customer, generated in accordance with an embodiment of the present invention;

FIG. 9 is a graphical representation of potential areas within the organization and/or the industry in which pain point processes may exist and where potential opportunities for increasing business value through increased usage and adoption of information worker products are most likely, generated in accordance with an embodiment of the present invention;

FIG. 10 is a graphical representation of potential scenarios that may be performed to increase business value through increased usage and adoption of an information worker product and the potential benefit resulting therefrom, generated in accordance with an embodiment of the present invention;

FIG. 11 illustrates a generated project plan overview that includes identification of existing problem issues and potential solutions that may be realized through increased usage and adoption of an information worker product, generated in accordance with an embodiment of the present invention;

FIG. 12 is a graphical representation of a key metric illustrating the potential improvement through implementation of the potential solutions identified for a potential problem issue, generated in accordance with an embodiment of the present invention;

FIGS. 13A and 13B illustrate a block diagram of an implementation process generated in accordance with an embodiment of the present invention;

FIG. 14 is a graphical representation of a project scorecard generated in accordance with an embodiment of the present invention;

FIG. 15 is a graphical representation of a solution tier generated in accordance with an embodiment of the present invention for providing assistance in determining adoption readiness and understanding solution complexity;

FIG. 16 is a graphical representation generated in accordance with an embodiment of the present invention for determining adoption readiness of a customer;

FIG. 17 is a state diagram graphically illustrating an importance ranking of different initiatives contained within a particular product plan, generated in accordance with an embodiment of the present invention; and

FIG. 18 is a graphical representation of a proposal section document generated in accordance with an embodiment of the present invention.

### DETAILED DESCRIPTION

To assist customers, such as businesses, organizations, individuals, etc., in utilizing existing and/or new versions of information worker products to their fullest extent, thereby increasing business value, a method, system, and framework has been developed to assist in identification of such opportunities and for assisting in interaction with those customers. Through that interaction, customers can increase adoption and high value usage of the most compelling features of information worker products that are relevant to a particular business scenario. In addition to increasing business value through increased adoption and usage, through interaction with customers, new information can also be obtained to further increase, improve, and customize future versions of information worker products to better fulfill the needs of the customers utilizing those products. Embodiments of the present invention organize, generate, and provide a process, deliverables, and templates needed to have high impact conversations with business decision makers within a customer's business.

The primary process for increasing business value through increased usage and adoption of information worker products includes envisioning the needs of a customer, discovering solutions to address those needs through increased adoption of one or more information worker products, and realization of the solution with the customer. The process is a deliberate and disciplined approach for identifying ways to increase business value by leveraging information worker products within the business. Generally described, the process is based on a defined set of principles, models, disciplines, concepts, guidelines, and improved practices as they relate to the implementation and increased usage of additional features and functionalities of information worker products. As will be described in more detail below, the process utilizes several different inputs that are created, generated and provided to the system through interaction with a customer. The process also creates numerous outputs, or deliverables, that are generated from those inputs that may be utilized to work with the customer in increasing business value through increased usage and adoption of identified information worker products. While embodiments of the present invention will be described with respect to software products, such as Word® and Excel®, embodiments of the present invention may be used to increase usage and adoption of any software product, and those discussed herein are provided as examples only and shall not be considered as limiting.

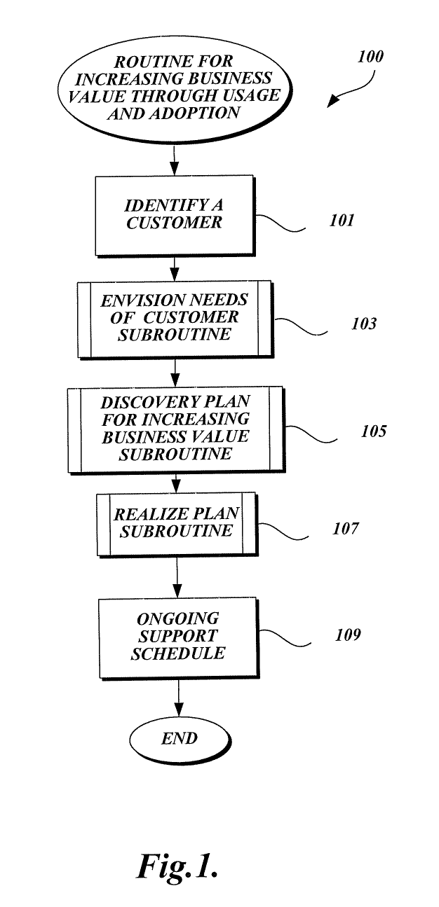

FIG. 1 is a high-level flow diagram illustrating the overall process for increasing business value through increased usage and adoption of one or more information worker products, in accordance with the embodiment of the present invention. At an initial point in the routine 100 a customer is identified. Any technique may be utilized for identifying a customer for use with embodiments of the present invention. A customer may be, for example, a business, an individual, or a large/small organization, etc., any of which utilize information worker products for which usage and adoption can be increased to increase business value. For example, the customer may be identified by the number of licenses to the particular information worker product, potential adoption of an information worker product within the company, or potential impact on a business that would result from increased usage and adoption of one or more information worker products.

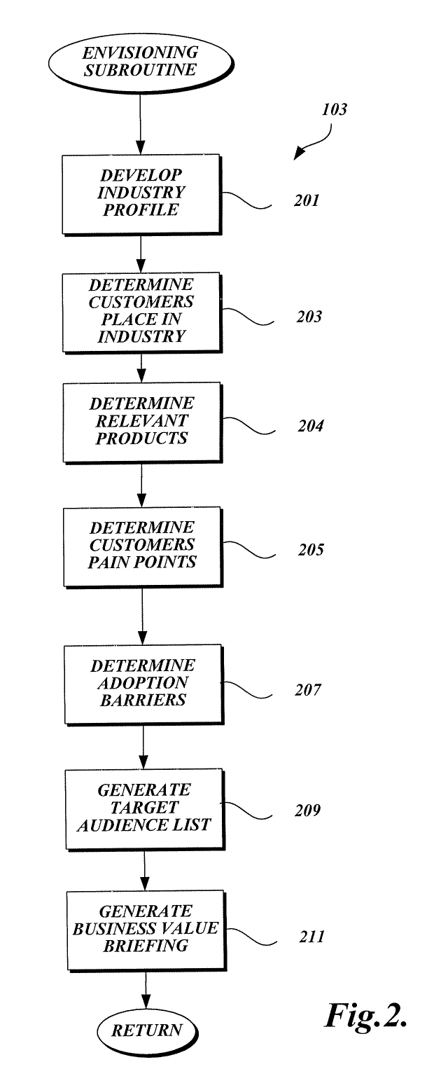

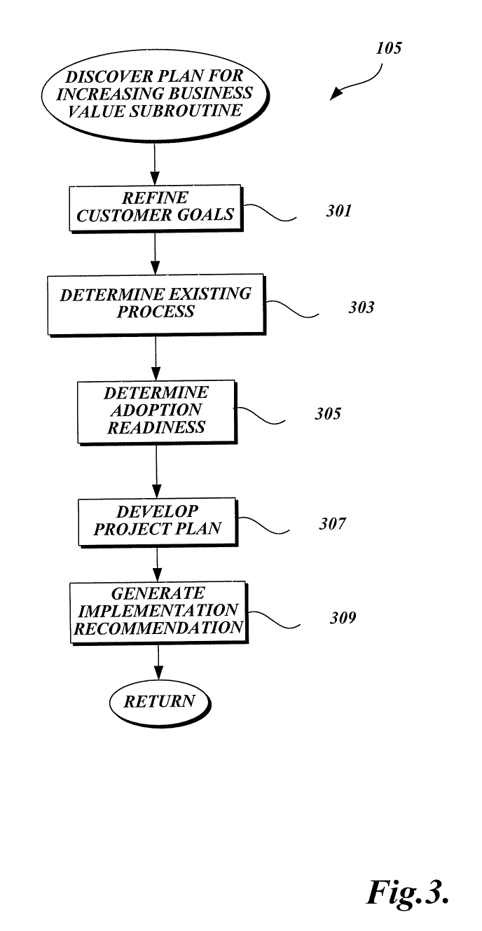

Upon identification of a customer at block 101, at subroutine block 103 the needs of the identified customer are envisioned. Envisioning needs subroutine 103 is described in more detail below with respect to FIG. 2. Once the needs of the customer have been envisioned at subroutine block 103, at subroutine block 105 a plan for increasing business value through increased adoption and usage of an information worker product is discovered. The discovery plan subroutine 105 is described in more detail with respect to FIG. 3 below.

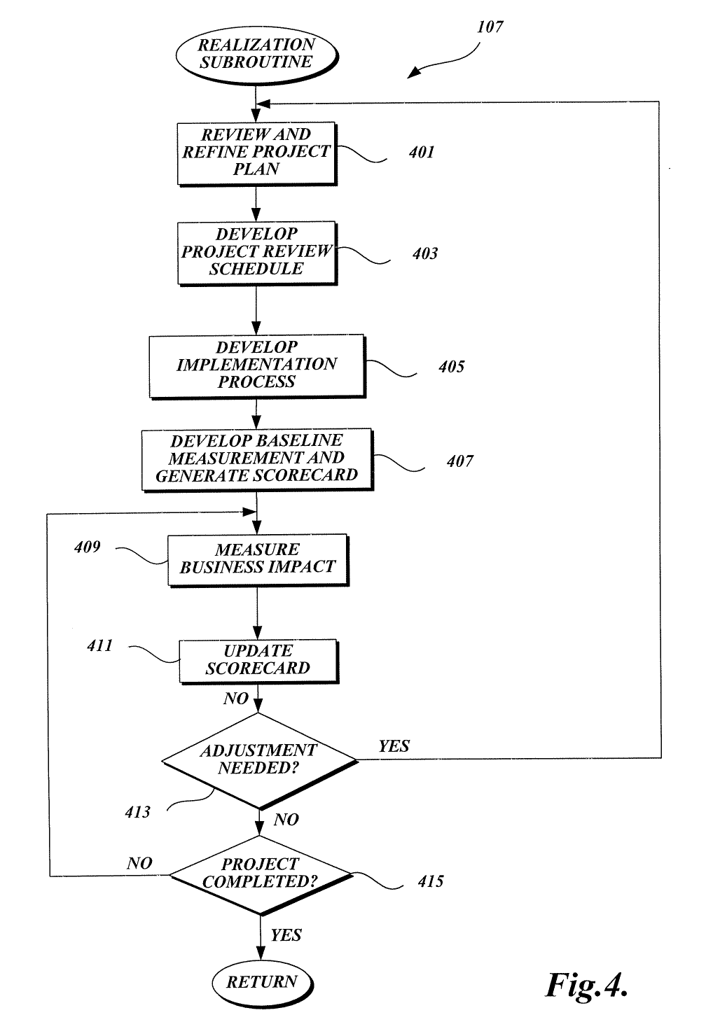

Upon discovering a plan through the discovery plan subroutine 105, at subroutine block 107 the plan is realized with the customer, thereby increasing business value for the customer through increased usage and adoption of an information worker product. The realizing plan subroutine 107 is described in more detail below with respect to FIG. 4.

Referring now to FIG. 2, the envisioning subroutine 103 of FIG. 1 will be described in more detail. Upon identification of a customer at block 101 (FIG. 1), an industry profile of the industry in which that customer operates is developed, as illustrated by block 201. In particular, embodiments of the present invention provide a strategy for understanding the industry in which the customer operates. For example, the routine may identify and/or provide industry profiles, identification of industry specialists that may be interviewed to gain additional information, and/or identify industry relevant solutions. Such information may be provided as input to the system or, according to various embodiments of the present invention, automatically obtained from accessible sources, such as the Internet.

Additionally, at block 203, the customer's place within that industry may be determined. For example, embodiments of the present invention may determine specific details about the customer and use that information to determine the customers place in the industry. Still further embodiments of the present invention may collect and provide history of executive sponsorships and identification of relevant business decision makers within the customer's organization. At block 204, current account information, account plans, and employment information of the relevant information worker products within the customer's organization is also determined.

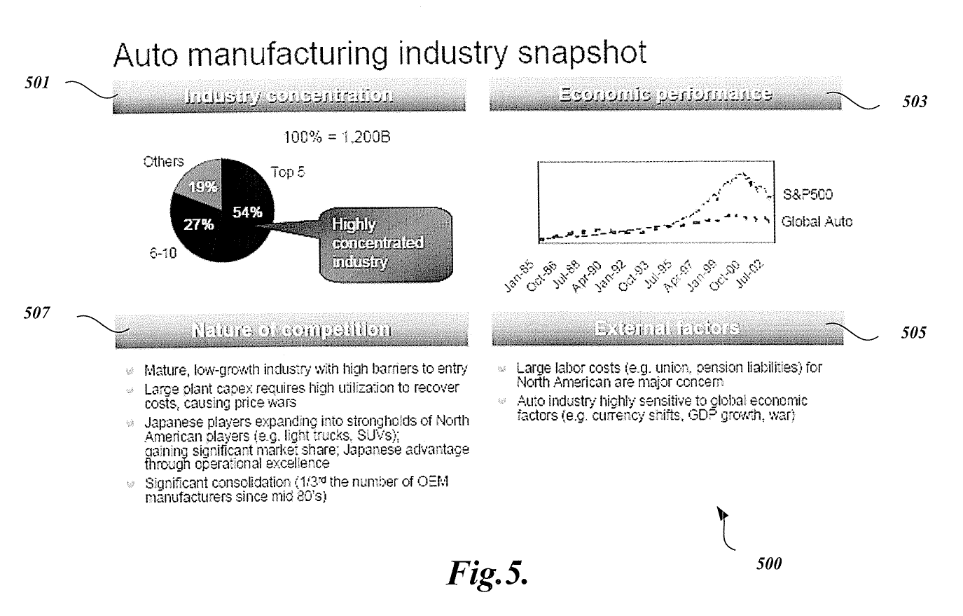

FIG. 5 illustrates a graphical representation of an industry profile snapshot that may be generated at block 201 in accordance with embodiments of the present invention and used to determine a customer's place within the industry. In this example, the industry profile snapshot 500 illustrated in FIG. 5 is an industry snapshot for the auto manufacturing industry. Information, such as industry concentration 501, economic performance 503, external factors 505, and nature of competition 507 may be automatically or manually obtained and a snapshot 500 of the information automatically generated. As can be seen from the snapshot 500, the auto manufacturing industry is a highly concentrated industry with over half of its sales being allocated to the top five organizations within that industry. Embodiments of the present invention, through internal analysis techniques that analyze the information regarding a particular industry, may be used to automatically generate an industry snapshot 500 for use in determining a customer's place within the industry, as is illustrated by block 203 (FIG. 2).

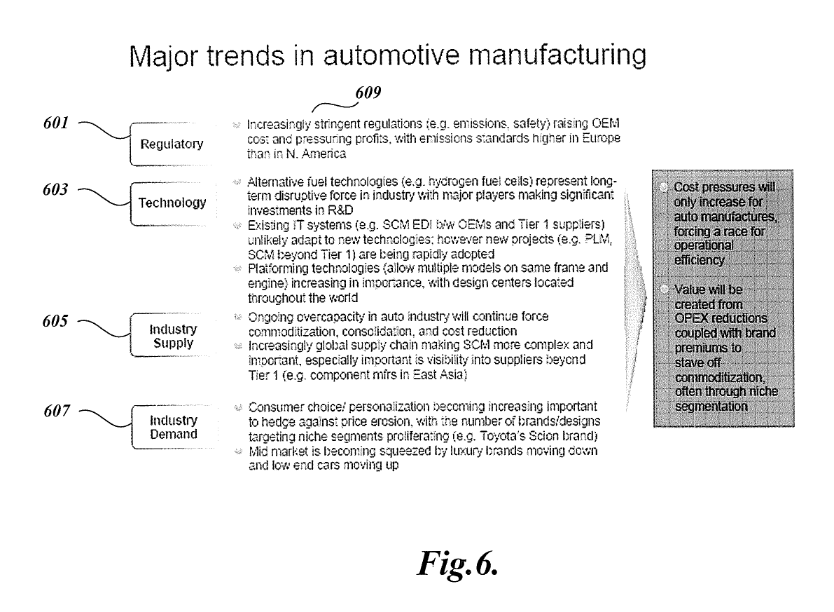

In addition to providing an industry snapshot 500, embodiments of the present invention, as part of developing an industry profile at block 201, may generate and identify major trends within the customer's industry. Referring to FIG. 6 and continuing with the previous example, major trends within the automotive manufacturing industry may include regulatory trends 601, technology trends 603, industry supply trends 605, industry demand trends 607, etc. For each industry trend, a brief summary 609 about the trend may be provided. For example, for the regulatory trend 601, embodiments of the present invention may determine and provide a summary 609 indicating that there are increasingly stringent regulations raising OEM costs and pressuring profits. The summaries 609 for each of the industry trends 601-607 may be used to identify value creation levers for the customers within its industry.

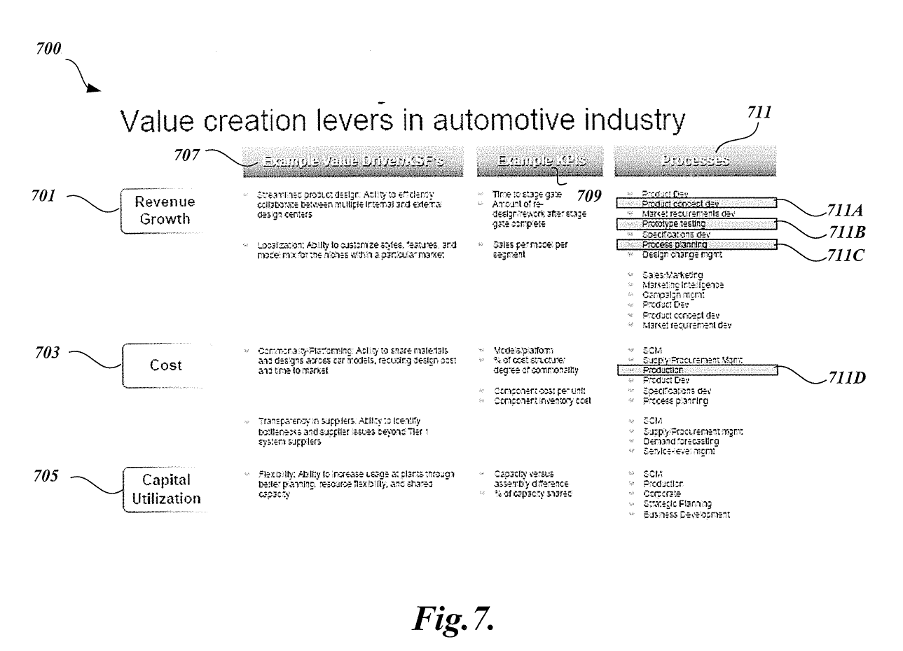

For example, FIG. 7 is a graphical representation of value creation levers that may be identified for a customer's industry, in this example the automotive industry, in accordance with an embodiment of the present invention. For example, the automotive industry has value creation levers that include revenue growth 701, cost 703, and capital utilization 705. Through understanding each value creation lever, value drivers 707, and key performance indicators 709 may be determined and processes 711 that are implemented to reach those key performance indicators 709 may be identified. For example, referring to FIG. 7, the three value creation levers for the automotive industry of revenue growth 701, cost 703, and capital utilization 705 may be identified and the corresponding value drivers 707, key performance indicators 709, and processes 711 for each of the value creation levers 701-705 may be determined from industry profiles 500, the customer's place within the industry, and industry trends 600. As discussed above, this information may be gathered and obtained from interviews with industry experts, literature, analyst reports, and/or through automated means, and automatically used to determine and understand value creation levers 700, as illustrated in FIG. 7.

Based on the industry profile 500 developed at block 201, the customer's place in the industry, as determined at block 203, major trends 600, value creation levers 700, and relevant information workers products identified at block 204, a hypothesis concerning customer “pain points” is developed at block 205. “Pain points,” as used herein, refers to areas within the customer's business where inefficiencies, weaknesses, or gaps exist. For example, customer pain points may include, but are not limited to, areas within the industry in which the customer are performing poorly, internal processes that are being performed inefficiently, areas where there is limited or no capability, etc.

Referring again to FIG. 7, based on the industry profile, the customer's place within the industry and relevant information worker products, particular processes 711 for each of the value creation levers 701-705 may be identified as including potential pain points for the customer. For example, processes of product concept development 711A, prototype testing 711B, processed planning 711C and production and production 711D may be identified by embodiments of the present invention as including potential pain points for the customer.

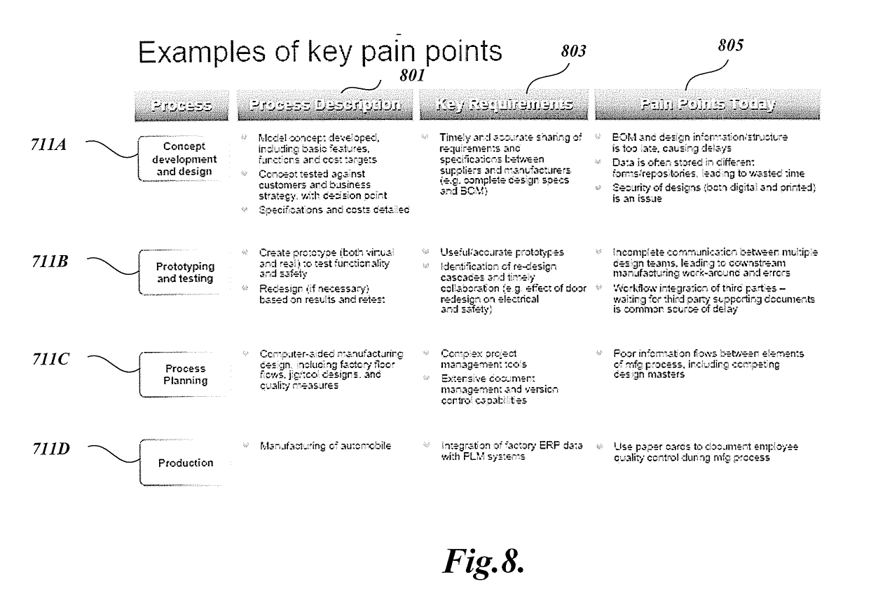

Referring to FIG. 8, for each identified process 711A-711D, detailed information regarding the process description 801, the key requirements for each process 803, and the existing pain points 805 of those processes 711A-711D may be identified and represented utilizing embodiments of the present invention. As will be described in greater detail below, upon identification of pain points, embodiments of the present invention may be used to identify which pain points can be resolved or reduced through the increased usage and adoption of information worker products and which of those pain points should be prioritized for increasing business value for the customer.

For example, embodiments of the present invention may identify pain points that can be resolved or reduced through the increased usage and adoption of information worker products by determining if those pain points fall into one or more classes. For example, in one embodiment of the present invention, available information worker products may be categorized into six different classes, including but not limited to, (1) helping ad hoc teams work together and share unstructured information, (2) enabling collaboration around formal structured processes and data, (3) eliminating rework and redundancy in paper based and time consuming processes, (4) managing complex document assembly, (5) creating intuitive and automated management tools, and (6) assisting with compliance, confidentiality, and privacy across the organization. Based on the defined classes, a determination may be made as to whether a particular pain point of a customer falls into one of those classes and thereby potentially resolvable through the increased usage and adoption of information worker products.

For each of the six defined classes, numerous capabilities may be realized by the information worker products that are available. For example, the class of “helping ad hoc teams work together and share unstructured information” includes three capabilities that may be realized through the increased usage and adoption of information worker products. In particular, the “helping ad hoc teams work together and share unstructured information” class provides the capabilities of (1) sharing documents and information readily across your organization and with external parties through intuitive portals, (2) allowing seamless, real-time communication, and (3) building and hosting an extranet site. Similarly, the class of “eliminating rework and redundancy in paper based and time consuming processes” provides at least four capabilities that may be realized to increase usage and adoption of information worker products. In particular, the “eliminating rework and redundancy in paper based and time consuming processes” includes the capabilities of (1) creating customized electronic forms and automation, (2) automating records management, (3) providing self-service sites, and (4) automating scheduling, calendaring, and resource usage. A pain point may be identified for a class based on the capabilities that can be used to resolve or improve that problem. While embodiments of the present invention identify six classes into which information worker products fall, any number and combination of classes may be used with embodiments of the present invention and those described herein are provided only as examples.

Referring again to FIG. 2, in addition to identifying potential pain points for the customer within that customer's industry that may be resolved or improved through the increased usage and adoption of information work products, barriers to adoption 207 for that customer may also be determined and used in selecting which pain points are to be focused on for increasing business value through increased information worker product usage and adoption. Examples of barriers to adoption include, but are not limited to, an inflexible workforce, such as a workforce that is highly regulated by the government or unions in which the employees of the customer are employed, highly intrinsic, or complex processes, such as product development, supply chain management, etc., that are slow to change and difficult to update. Other barriers to adoption include logistics regulations, such as supply chain organization and production for workforce skills of the individuals within the workforce in using and improving the adoption and usage of the information worker product. Still further, selection of pain points that may be improved or resolved through the increased usage and adoption of information worker products may also be determined based on the potential adoption readiness of the customer and based upon the complexity of the solution to be implemented.

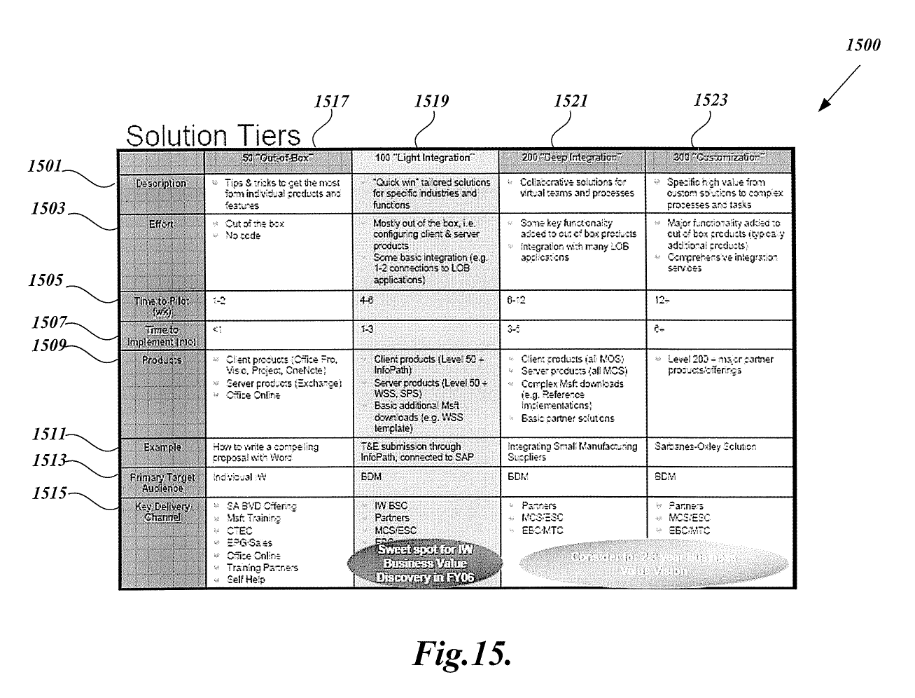

FIG. 15 is a graphical representation of a solutions tier generated in accordance with an embodiment of the present invention for providing assistance in determining adoption readiness of a customer and understanding solution complexity of a potential solution. Generally described, the solutions tier 1500 identifies the level of complexity of a particular solution. For each level of complexity, a description of the effort involved in realizing the solution, the time required to complete a pilot of the solution, the time to actually implement a full roll-out of the solution, the information worker products that will be utilized by the solution, an example of the solution that will be realized, the primary target audience of the solution, and the key delivery channels may also be provided.

In the exemplary solutions tier graph for representation 1500, there are four levels of complexity including an out-of-the-box 1517 level of complexity, a light integration 1519 level of complexity, a deep integration 1521 level of complexity, and a customization 1523 level of complexity. As can be seen from the different levels of complexity 1517-1523, the ability of the customer, the time desired to realize a solution, and many other factors are relevant in prioritizing a particular pain point/solution. For example, if the customer is not sophisticated in their use of information worker products and would like to see a quick realization, it may be beneficial to identify a solution that falls under the complexity rating of out-of-the-box 1517.

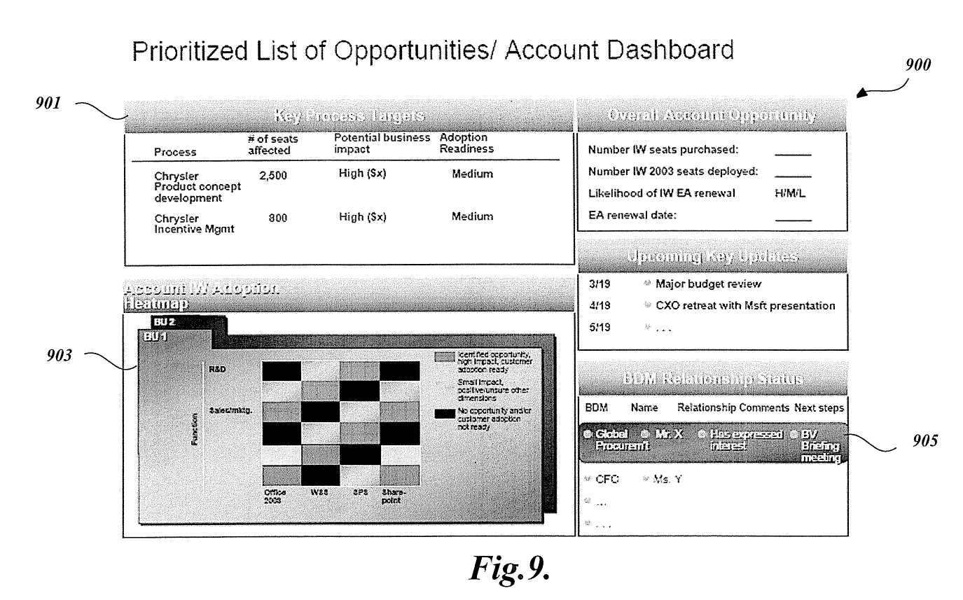

FIG. 9 is a graphical representation generated by an embodiment of the present invention that identifies and illustrates potential areas within the organization and/or the industry in which pain points may exist and where potential opportunities 903 for increasing business value through increased usage and adoption of an information worker product are most likely. Through utilization of a graphical representation 900, such as that illustrated in FIG. 9, a target audience 905 may be identified based on the opportunities and the pain point hypothesis, as illustrated by block 209 (FIG. 2). Included as part of the process for identifying a target audience, a number of prioritized selection criteria may be considered for each of the potential individuals to be included on the target audience list. For example, items of a highest priority may include the need to add to the target audience list a business decision-maker, such as a COO, CFO, CEO, etc. Following in order of priority for the selection of an individual for inclusion in the target audience list may be a determination as to the relationship or willingness to engage by that individual. Another criteria for selection may include identification of an individual responsible for a large or an important organization within the customer's value chain or an identification of an individual responsible for a division that can add significant value to the customer. Another point of consideration may also include identification of a target audience based on that audience's readiness for adoption of the information worker products or whether that target audience plays an influential role in the process and decision of whether to purchase and/or upgrade information worker products for use in executing a potential solution. Typically, target audiences within a custorner's organization include senior business decision makers, such as CEOs, CFOs, COOs, business unit leads, and functional leads who run the business units and functions within the customer's organization. Additionally, the target audience list generated at block 209 may include several levels of business process owners that report within the business decision makers' organizations to further understand the specific processes, process requirements, and success matrices that will define high value for the customer through increased usage and adoption. Based on materials obtained and generated at blocks 201-209, a business value briefing schedule can be generated for use in meeting with the identified target audience, as illustrated by block 211.

Utilizing the briefing schedule and the materials generated regarding the industry, the customers place within the industry, and customer pain points, meetings with the target audience and key business decision makers may be performed. Those conversations can be clearly focused on the customer's placement within the industry, existing information worker product usage and adoption, and potential pain points within the customer's organization that may be improved through a higher usage and adoption of information worker products. Through those conversations, refinement of pain points and agreement from the business decision maker as to a plan for improving business value through usage and adoption can be realized.

Referring now to FIG. 3, which provides a more detailed explanation of the discovery plan subroutine 105, at block 301, based on discussions with key business decision makers, the goals of that customer, and prioritization of the potential pain points for which improvement may be realized is refined. Additionally, if experts within the customer's organization are critical for improving efficiency of a particular pain point, those experts may be identified and a valuation per solution based on solution guidelines and business decision maker input may also be generated for use in refining the customer's goals and prioritizing improvement of different pain points. The value of each potential solution based on those guideline lines and the adoption readiness may be estimated, determined, and utilized in refining the customer's goals, as illustrated by block 301.

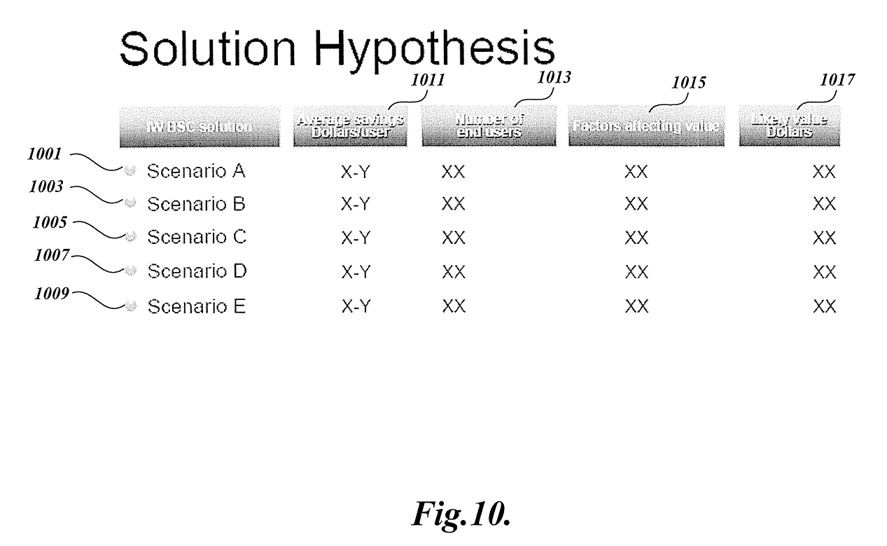

For example, referring to FIG. 10, five different scenarios for removing or improving different pain points may the identified, such as Scenario A 1001, Scenario B 1003, Scenario C 1005, Scenario D 1007, and Scenario E 1009. Each scenario will include an average savings dollar per user 1011, existing number of individuals within that customer's organization that utilize the information worker product(s) that will be used as part of the solution for each of the Scenarios 1001-1009, the factors affecting the value 1015 of each of the different scenarios, and the likely value increase in dollars 1017 to be realized by the scenario. The likely value of dollars increased is computed based on the average savings per user 1011, the number of users 1013, and the factors affecting value 1015. Based on the likely value of dollars 1017, the Scenarios 1001-1009 are prioritized.

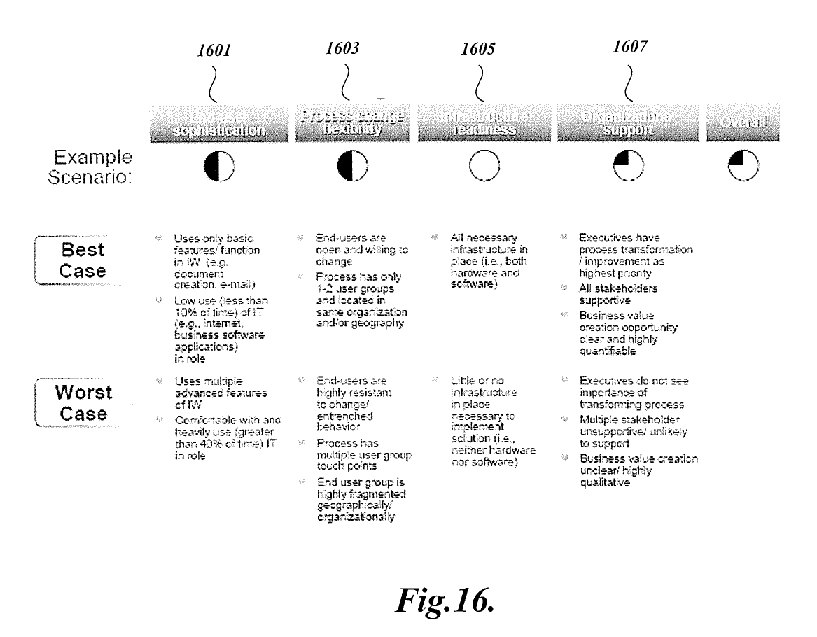

In addition to prioritizing different scenarios 1001-1009 based on likely value of dollars 1017 realized, scenarios may be prioritized based upon the customer's adoption readiness. A customer's adoption readiness may be determined based upon, for example, the customer's sophistication, process change flexibility of the customer, infrastructure readiness, and organizational support. Referring to FIG. 16 for a particular scenario, additional considerations for prioritizing those scenarios may be graphically represented and determined as to whether it is a best-case or worst-case for that particular scenario. For example, the end-user or customer sophistication level 1601 in a best-case situation may identify only the basic features/functions of the information worker product that is necessary for realizing the scenario. Likewise, under a best-case, the scenario only requires a low use of information technology. In contrast, under a worst-case situation, the end-user sophistication 1601 would require multiple advanced features of the information worker product to realize the scenario and also would require that the customer be comfortable with and be willing to indulge in heavy usage of the information worker product and heavy usage of the customer's information technology support team. Another factor in determining and prioritizing potential scenarios is the process change flexibility 1603 wherein in a best-case situation, end-users are open and willing to change and the process only has one or two user groups that are located in the same geography or organization.

In contrast, the process change flexibility may identify a worst-case situation that may result in a lower prioritization of the scenario if the customer's end-users are highly resistant to change, the process requires multiple user group touch points, or the end-user group is highly fragmented geographically or organizationally. Another factor in prioritizing potential scenarios is the infrastructure readiness 1605. Infrastructure readiness 1605 may be determined for a potential scenario based on whether all of the necessary infrastructure is in place within the customer's organization. Finally, a fourth factor in prioritizing potential scenarios for implementation is the organizational support of the customer itself 1607, which categorizes whether the executives have process transformation as a high priority, whether the stakeholders involved in any change would be supportive, and whether the business value creation opportunity through the increased usage and adoption of the information worker products is highly quantifiable. Based on the end-user sophistication 1601, process change flexibility 1603, infrastructure readiness 1605, and the organizational support 1607, an overall best or worst-case scenario of ranking may be provided and used as an additional consideration in prioritizing the different scenarios for implementation with the customer.

In addition to refining customer goals at block 301, embodiments of the present invention may generate guidelines and information for use in determining and understanding existing processes, as illustrated by block 303. For example, guidelines for use in discussing and understanding existing process issues and usefulness of potential solutions that may be provided through increased adoption and usage of information worker products may be generated utilizing embodiments of the present invention. For example, generation of questions that may be used in assisting in the understanding of: current process steps, existing pain points, key performance indicators, existing usage/understanding of a particular information worker product, etc., may be generated for use in discussing those topics with key business decision makers. Likewise, questions may be generated for use in discussions with business process owners to determine whether the pain points hypothesis generated by the envisioning subroutine 103 will address the customer's actual pain points.

In addition to determining and understanding existing processes, at block 305, the adoption readiness of the individuals within the customer's organization or the customer itself may be determined and used again in prioritizing and refining the scenarios for use in improving business value through increased usage and adoption of information worker products.

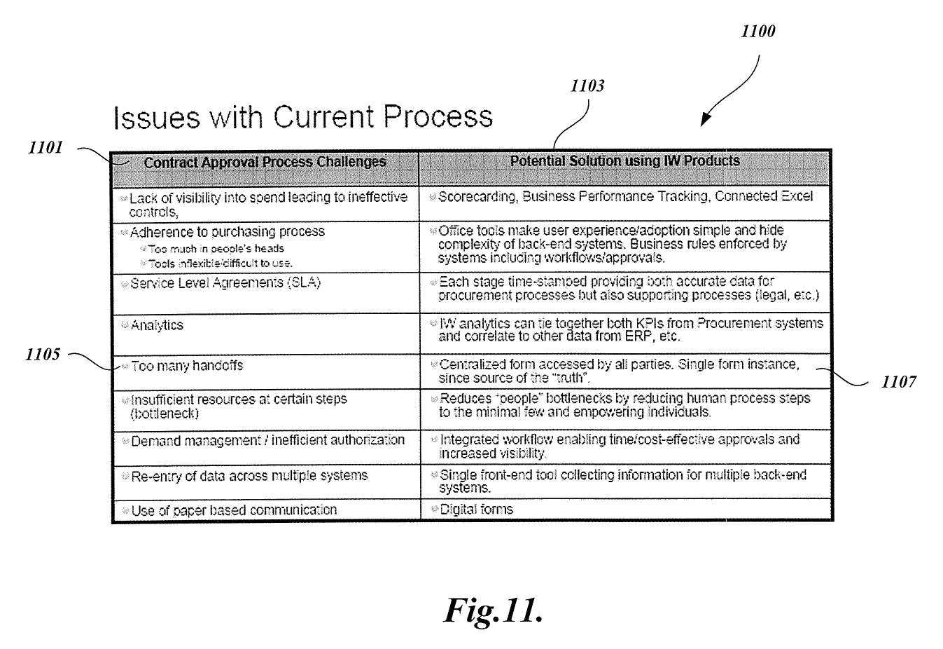

Based on the refined customer goals generated at block 301, the existing process determined at block 303 and the adoption readiness determined at block 305, a project plan overview may be generated which identifies problem issues of current processes and potential solutions that may be implemented through increased usage and adoption of existing and/or new information worker products, according to the embodiment of the present invention. For example, FIG. 11 illustrates a generated project plan overview that includes identification of existing problem issues of a contract approval process 1101 and potential solutions 1103 that may be realized through increased usage and adoption of existing information worker products. The table 1100 includes a list of each of the different challenges with the existing contract approval process and a potential solution for each of those challenges that can be realized through increased usage and adoption of various information worker products. For example, too many handoffs 1105 may be identified as a potential problem in the contract approval process and the potential solution 1107 of providing a centralized form that is accessed and used by all parties through increased usage and adoption of Word® may be described.

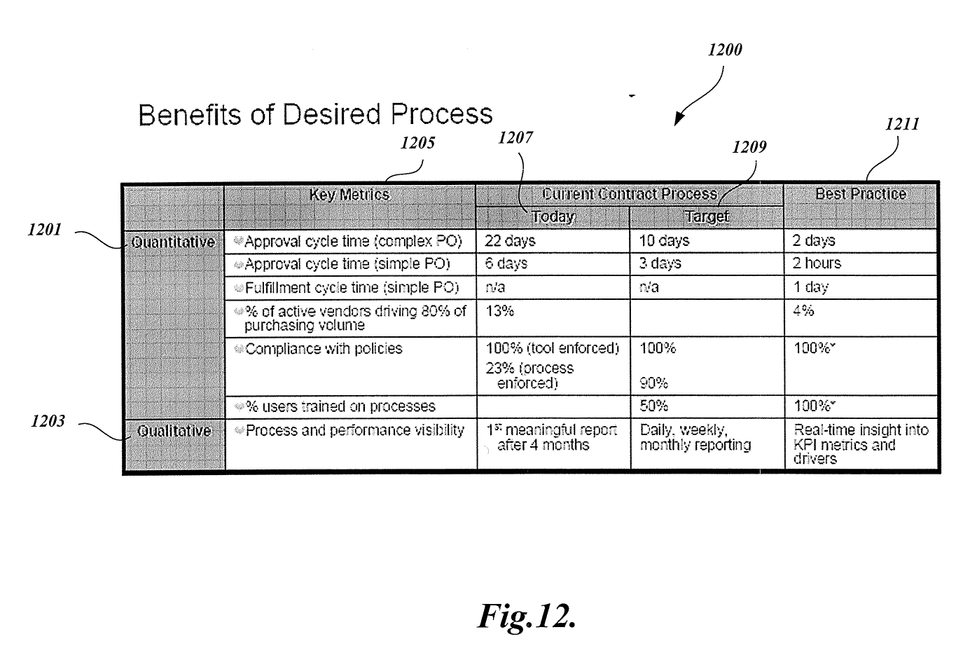

In addition to the identification of problem issues with the current process and explanation of potential solutions, illustrated graphically in FIG. 11, embodiments of the present invention may also generate a key metric illustrating the potential improvement through implementation of the potential solutions identified for a potential problem issue, as illustrated by FIG. 12. The benefits may include both quantitative 1201 and qualitative 1203 benefits organized by key metrics 1205. The current rate for each key metric 1205 may be provided illustrating both today's current rate 1207 and the projected target rate 1209, thereby illustrating the potential benefit from implementation of increased usage and adoption of an information worker product. Additionally, a best practices column 1211 may be included identifying the best practice for each of the qualitative and quantitative key metrics for a process that has been identified as a potential pain point for the customer.

Returning now to FIG. 3, once a project plan overview has been developed at block 307, at block 309, an implementation recommendation may be generated and provided that identifies a detailed description of the existing problem with a particular technique and the project plan for improving that problem through increased usage and adoption of one or more information worker products. A timeline for implementation of the pilot program and full deployment may also be generated using embodiments of the present invention.

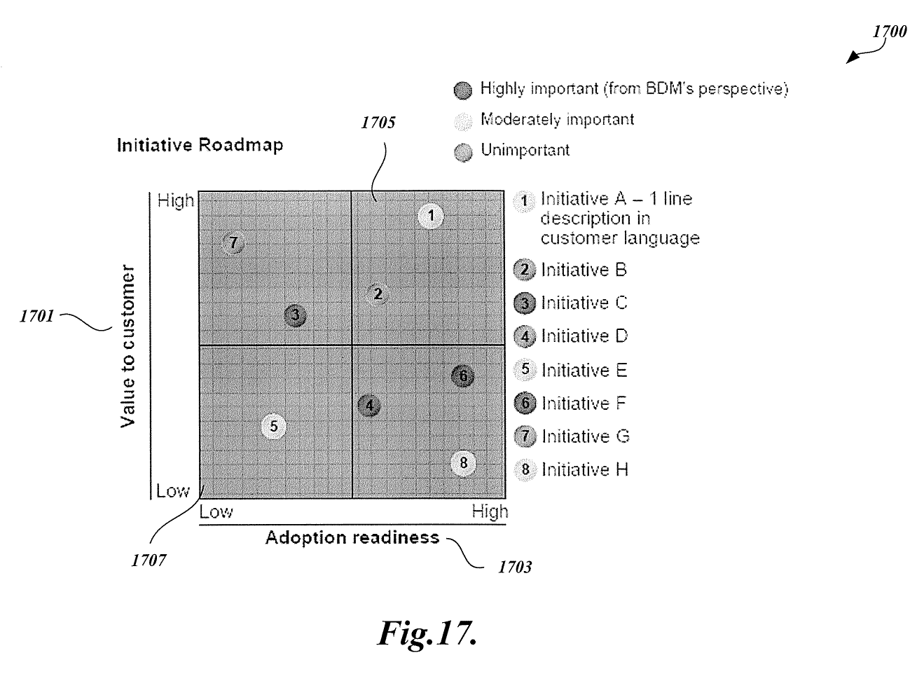

As part of the project plan, a state diagram graphically illustrating an importance ranking of different initiatives contained within a particular project plan may be generated in accordance with an embodiment of the present invention for assistance in identifying if there are any initiatives within that plan that are of a lower priority. Referring to the state diagram 1700 of FIG. 17, embodiments of the present invention may provide a graph illustrating, on a vertical axis 1701, the value to the customer that will be realized by the particular initiative of the project plan, and on a horizontal axis 1703, the adoption readiness of that customer for the particular initiative that is part of the project plan.

Based on a comparison of the value to the customer and the adoption readiness, different initiatives may be prioritized and selected as highly important, moderately important, or unimportant. In particular, initiatives included in the top right quadrant 1705 may be classified as highly important initiatives for realizing the customers' goals in executing the project plan. In contrast, initiatives located in the lower left quadrant 1707 may be identified and classified as unimportant and, therefore, not necessary to execute in realizing the goals of the customer of the project plan.

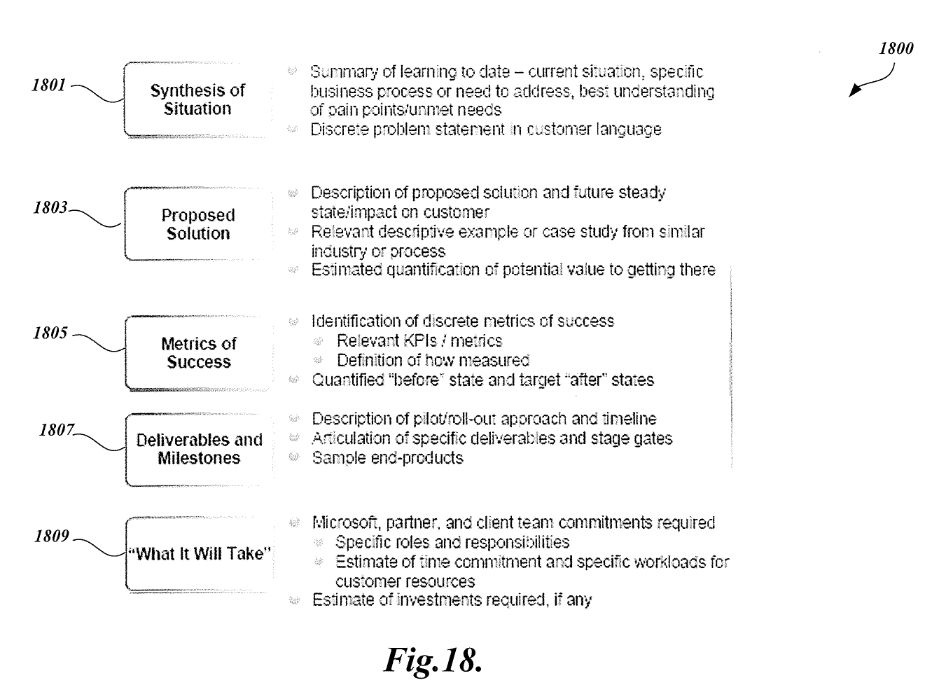

FIG. 18 is a graphical representation of a proposal section document generated in accordance with an embodiment of the present invention for providing a high-level overview of the project plan proposal that has been selected for implementation that will result in the increased usage and adoption of information worker products, in accordance with embodiments of the present invention. As can be seen by the graphical representation 1800, the proposal section document includes a synthesis of the situation 1801, a proposed solution 1803, the metrics 1805 that will be used for measuring the success of that solution, identification of the deliverables and milestones 1807 for that solution, and what it will take 1809 to realize the solution.

The synthesis of the situation 1801, proposed solution 1803, metrics of success 1805, deliverables and milestones 1807, and what it will take 1809 may be automatically generated and graphically represented. For example, the proposal section document 1800 may be automatically generated based on the information collected and the discussions that have been accomplished with the customer in identifying and prioritizing the different solutions and the initiatives of those solutions and how the selected solution is to be executed via a project plan.

FIG. 4 is a flow diagram illustrating the details of the realization subroutine 107 used for increasing business value through usage and adoption of existing information worker products, in accordance with an embodiment of the present invention. As part of the realization subroutine 107, at an initial point, a final review and refinement of the project plan or implementation plan is performed before initiation of a pilot program. The pilot program is used for testing and validating the project plan to confirm that it will meet the target goals for improving business value through increased usage and adoption of information worker products, as illustrated by block 401. In addition, at block 403 a project review schedule may be established for identifying the frequency with which the project is to be reviewed and improvements graded, as discussed below.

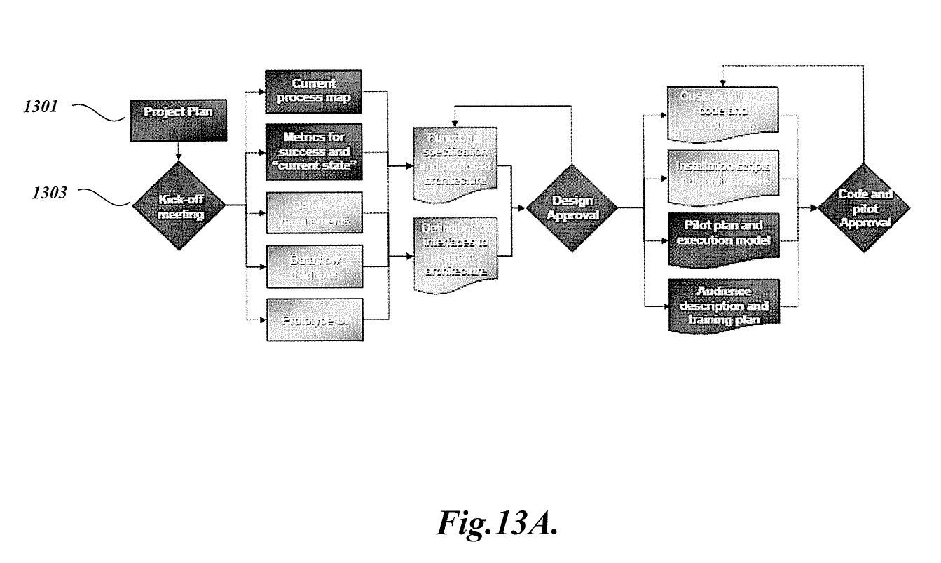

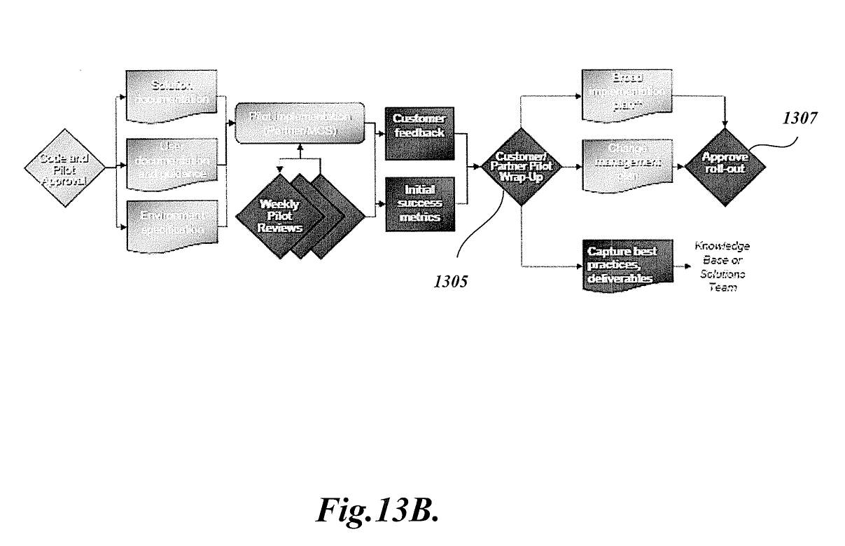

At block 405 an implementation process graphically illustrating the project plan from initiation to finalization may be generated for use in monitoring the progress of the project plan. For example, referring to FIGS. 13A and 13B, an implementation process may be generated that identifies the logical transition of the project plan 1301 from the kickoff meeting 1303 (FIG. 13A) through the completion of the pilot program 1305 (FIG. 13B) into final rollout of the approved plan 1307 (FIG. 13B).

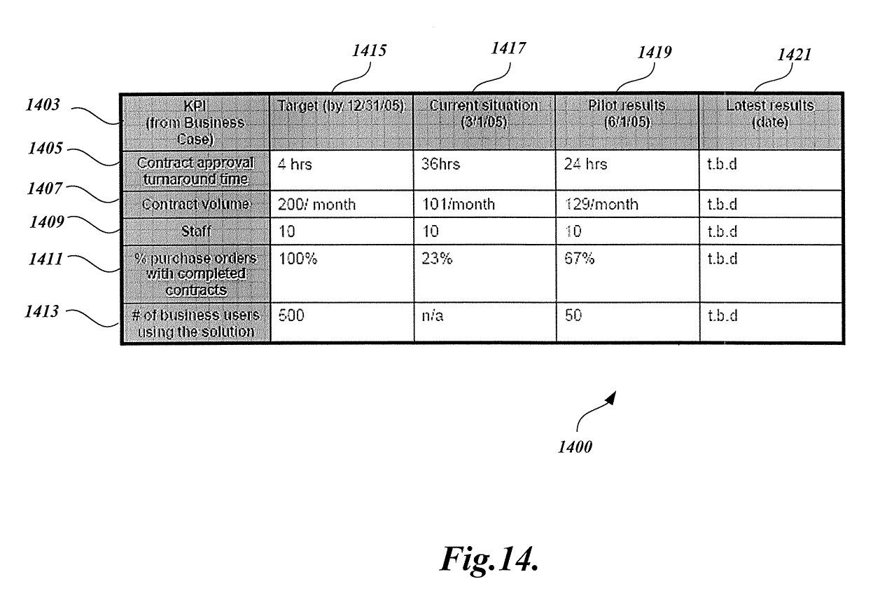

Returning to FIG. 4, at block 407, a baseline measurement of the existing pain point for which the project will be implemented is determined. A scorecard 1400 (FIG. 14) may be generated for continued monitoring and scoring of the project as it is carried out. A project scorecard 1400, as illustrated in FIG. 14, may include key performance indicators 1403 for the pain point, such as the contract approval turnaround time 1405, contract volume 1407, staff 1409, percentage of purchase orders with completed contracts 1411, and a number of business users using the solution to improve the process 1413. In addition, the project scorecard may include a target goal for each of the key performance indicators 1415, the current status or baseline measurement 1417 for each of the key performance indicators, the pilot results 1419 as they are completed, and the latest results 1421 as they are reviewed in accordance with the project review schedule developed at block 403.

As the project is realized, at various points in time, in accordance with the developed project review schedule, the business impact resulting from the project is measured, as illustrated by block 409. The scorecard 1400 is updated, as illustrated by block 411, to graphically represent the progress and improvement that is resulting from the increased usage and adoption. At decision block 413, it is determined whether an adjustment to the project plan is needed. An adjustment to the project plan may be needed if, for example, the milestones are not being met, if the expected results are not being realized, if the project is not going according to schedule, etc. If it is determined at decision block 413 that an adjustment is needed, control returns to block 401, and the subroutine 107 continues. However, if it is determined at block 413 that an adjustment is not needed, at decision block 415 it is determined whether the project or the pilot program has completed. If it is determined at decision block 415 that the project is not completed, control returns to block 411, and at the scheduled review times, the business impact is measured and the subroutine continues. If it is determined at decision block 415 that the project has completed, the realization subroutine completes and returns control to the routine for increasing business value through increased usage and adoption (FIG. 1).

Finally, returning to FIG. 1, upon completion of the realization of the project plan subroutine 107, at block 109 an ongoing support schedule may be established for ongoing support of the customer for the continued adoption and usage of information worker products to further increase usage and adoption of those products.

While illustrative embodiments have been illustrated and described, it will be appreciated that various changes can be made therein without departing from the spirit and scope of the invention.

1. A method for increasing customer business value through increased usage and adoption of information worker products, comprising:
envisioning a need of a customer;
discovering a solution to address the need;
realizing the solution with the customer; and
tracking a business value change of the realized solution.

2. The method of claim 1, wherein envisioning a need of a customer includes determining a current status of the customer; and
determining a desired future status of the customer.

3. The method of claim 1, wherein envisioning a need of a customer includes generating a pain point hypothesis of the customer.

4. The method of claim 3, wherein the pain point hypothesis identifies a potential problem area of the customer within the industry than can be addressed with an information worker product.

5. The method of claim 4, wherein the potential problem area is determined based on a processes currently implemented by the customer.

6. The method of claim 1, wherein discovering a need of a customer includes determining an existing process performed by the customer; and
developing an implementation recommendation for resolving that need through the increased usage and adoption of an information worker product.

7. The method of claim 6, wherein generating an implementation recommendation includes determining an adoption readiness identifying the readiness of the customer for adopting a potential solution.

8. The method of claim 6, wherein generating an implementation recommendation includes developing a project plan overview identifying the existing problem issues with a process and the proposed solutions for those problem issues.

9. The method of claim 1, wherein realizing the solution with the customer includes executing a pilot program that confirms a solution plan for increasing business value through increased usage and adoption of an information worker product.

10. A computer-readable medium having computer executable components for envisioning a need of a customer that can be satisfied through increased usage and adoption of an information worker product, comprising:
an industry profile development component configured to obtain information about an industry in which the customer operates and to determine the customers place within the industry;
a pain point component for identifying potential pain points of the customer that can be resolved or improved through increased adoption and usage of an information worker product;
a target audience determination component configured to identify a target audience within the customer's organization; and
a business value briefing component configured to generate business value briefing material for use in communicating with the target audience.

11. The computer-readable medium of claim 10, further comprising:
an adoption readiness component configured to determine a readiness of a customer to adopt a solution that involves the increased usage and adoption of an information worker product.

12. The computer-readable medium of claim 10, wherein the target audience list identifies business decision makers within the customer's organization.

13. The computer-readable medium of claim 10, wherein the business value briefing includes an overview of potential customer pain points, industry profile, the customer's place in the industry; and solutions to the potential customer pain points.

14. A method for realizing a plan for improving business value of a customer through the increased usage and adoption of an information worker product, comprising:
refining a project plan for increasing usage and adoption of an information worker product;
developing a project review schedule specifying times within a pilot program for reviewing and grading a progress of the project;
determining a baseline measurement of a customer pain point that is to be improved through the increased usage and adoption of the information worker product;
implementing a pilot program to increase the usage and adoption of the information worker product; and
periodically reviewing and measuring a progress of the program.

15. The method of claim 14, further comprising:
generating a score card identifying key performance indicators for measuring the progress of increased business value resulting from increased usage and adoption of the information worker product.

16. The method of claim 15, further comprising:
updating the scorecard with a current measurement of the progress that is taken periodically.

17. The method of claim 14, further comprising:
generating a scorecard configured to measure and represent an improvement in business value resulting from increased usage and adoption of the information worker product; wherein the scorecard includes a target improvement, a current measurement, and a result of a pilot program.

18. The method of claim 14, further comprising:
determining an ongoing support schedule.

19. The method of claim 18, wherein the ongoing support schedule identifies a schedule upon which ongoing support to further increase usage and adoption of the information worker product is specified.

20. The method of claim 14, further comprising:
wherein refining the project plan includes reviewing an adoption readiness of the customer and the potential increase in business value to the customer that is to be realized through implementation of the project plan.
